(19) United States
(12) Patent Application Publication
(10) Pub. No.: US 2022/0037932 A1
(43) Pub. Date: Feb. 3, 2022

(54) FOREIGN SUBSTANCE DETECTION DEVICE, ELECTRIC POWER TRANSMISSION DEVICE, ELECTRIC POWER RECEPTION DEVICE, AND ELECTRIC POWER TRANSMISSION SYSTEM

(71) Applicant: TDK CORPORATION, Tokyo (JP)

(72) Inventor: Akira GOTANI, Tokyo (JP)

(73) Assignee: TDK CORPORATION, Tokyo (JP)

(21) Appl. No.: 17/365,308

(22) Filed: Jul. 1, 2021

(30) Foreign Application Priority Data
Jul. 29, 2020 (JP) 2020-128602

(51) Int. Cl. H02J 50/60; H02J 50/12; B60L 53/124

(52) U.S. Cl. CPC H02J 50/60; H02J 50/80; B60L 53/124; H02J 50/12

(57) ABSTRACT

The detector of a foreign substance detection device determines the presence or absence of a foreign substance on the basis of the results of comparison between a value for comparison, based on an output value from a sensor, and threshold values. The threshold values include a first threshold value and a second threshold value that is greater than the first threshold value. The detector determines that the foreign substance is present when the number of times at which the value for comparison exceeds the first threshold value reaches the first number of times, and determines that the foreign substance is present when the number of times at which the value for comparison exceeds the second threshold value reaches the second number of times smaller than the first number of times.

### CROSS-REFERENCE TO RELATED APPLICATION

This application claims the benefit of Japanese Patent Application No. 2020-128602, filed on Jul. 29, 2020, the entire disclosure of which is incorporated by reference herein.

### FIELD

The present disclosure relates to a foreign substance detection device, an electric power transmission device, an electric power reception device, and an electric power transmission system.

### BACKGROUND

Wireless electric power transmission technologies, by which electric power is wirelessly transmitted, have received attention. The wireless electric power transmission technologies enable electric power to be wirelessly transmitted from an electric power transmission device to an electric power reception device, and are therefore expected to be applied to various products such as transportation equipment such as trains and electric vehicles, household electric appliances, radio communication equipment, and toys. In the wireless electric power transmission technologies, an electric power transmission coil and an electric power reception coil, linked by a magnetic flux, are used for transmitting electric power.

When a foreign substance, of which examples include metal pieces, is present in the vicinities of the electric power transmission coil and the electric power reception coil, various problems may occur. For example, such a foreign substance may adversely affect transmission of power from the electric power transmission coil to the electric power reception coil, or may result in eddy current, whereby heat may be generated. Accordingly, a technology to appropriately detect a foreign substance present in the vicinities of the electric power transmission coil and the electric power reception coil is desired.

Patent Literature 1 describes a power feeding device that applies a voltage between two electrodes, and that detects a foreign substance on the basis of the amount of change in impedance between the two electrodes. The power feeding device determines the kind of the foreign substance by comparing the amount of change in the impedance with two threshold values. Patent Literature 2 describes a non-contact power feeding device that compares a potential difference between a voltage between both ends of a battery and a voltage between both ends of a capacitor for smoothing with a determination threshold value to detect abnormal power feeding caused by the presence of a foreign substance. When the potential difference exceeds the determination threshold value at the specified number of times, the non-contact power feeding device determines that the abnormal power feeding occurs, that is, the foreign substance is present.

### SUMMARY

However, it is difficult to immediately detect a foreign substance with high precision in both the power feeding device described in Patent Literature 1 and the non-contact power feeding device described in Patent Literature 2. For example, the power feeding device described in Patent Literature 1 determines that a foreign substance is present when the amount of change in the impedance exceeds the threshold values even once. Therefore, false detection may occur in the power feeding device. In the non-contact power feeding device described in Patent Literature 2, it may be difficult to adjust the specified number of times to the appropriate number of times because the small specified number of times results in the increased risk of false detection while the large specified number of times results in the need for time to detect a foreign substance.

The present disclosure was made in view of the problems described above, with an objective of immediately detecting a foreign substance with high precision in wireless electric power transmission.

To solve the problems described above, a foreign substance detection device according to one embodiment of the present disclosure includes:

a sensor, and

a detector that determines presence or absence of a foreign substance based on results of comparison between a value for comparison, based on an output value from the sensor, and threshold values, wherein

the threshold values include a first threshold value and a second threshold value that is greater than the first threshold value, and

the detector determines that the foreign substance is present when a number of times at which the value for comparison exceeds the first threshold value reaches a first number of times, and determines that the foreign substance is present when a number of times at which the value for comparison exceeds the second threshold value reaches a second number of times smaller than the first number of times.

In accordance with the foreign substance detection device including such a structure as described above, the foreign substance can be immediately detected with high precision in the wireless electric power transmission.

### BRIEF DESCRIPTION OF THE DRAWINGS

A more complete understanding of this application can be obtained when the following detailed description is considered in conjunction with the following drawings, in which:

FIG. 1 is a schematic configuration view of an electric power transmission system according to Embodiment 1;

FIG. 2 is an arrangement drawing of a foreign substance detection device according to Embodiment 1;

FIG. 3 is a plan view of the foreign substance detection device according to Embodiment 1;

FIG. 4 is a plan view of a detection coil unit according to Embodiment 1;

FIG. 5 illustrates an equivalent circuit of a resonant circuit included in the detection coil unit according to Embodiment 1;

FIG. 6 is a configuration view of a detector included in the foreign substance detection device according to Embodiment 1;

FIG. 7 is a first graph indicating a correspondence relationship between the number of measurements and a difference value;

FIG. 8 is a second graph indicating a correspondence relationship between the number of measurements and a difference value;

FIG. 9 is a flow chart illustrating a foreign substance detection process executed by the foreign substance detection device according to Embodiment 1;

FIG. 10 is a flow chart illustrating an individual comparison process illustrated in FIG. 9;

FIG. 11 is a flow chart illustrating a foreign substance detection process executed by a foreign substance detection device according to Embodiment 2;

FIG. 12 is a flow chart illustrating a foreign substance detection process executed by the foreign substance detection device according to Embodiment 3;

FIG. 13 is a flow chart illustrating a loop coil selection process illustrated in FIG. 12;

FIG. 14 is a flow chart illustrating a foreign substance detection process executed by the foreign substance detection device according to Embodiment 4; and

FIG. 15 is an arrangement drawing of a foreign substance detection device according to Embodiment 5.

### DETAILED DESCRIPTION

Electric power transmission systems according to embodiments of a technology according to the present disclosure will be described below with reference to the drawings. In the following embodiments, the same components are denoted by the same reference characters. The ratios of the sizes, and shapes of components illustrated in each drawing are not necessarily identical to those in practice.

### Embodiment 1

The electric power transmission system according to the present embodiment can be utilized in charge of the secondary batteries of various devices such as electric vehicles (EV), mobile devices such as smartphones, and industrial equipment. An example of a case in which the electric power transmission system executes charge of the storage battery of an EV will be described below.

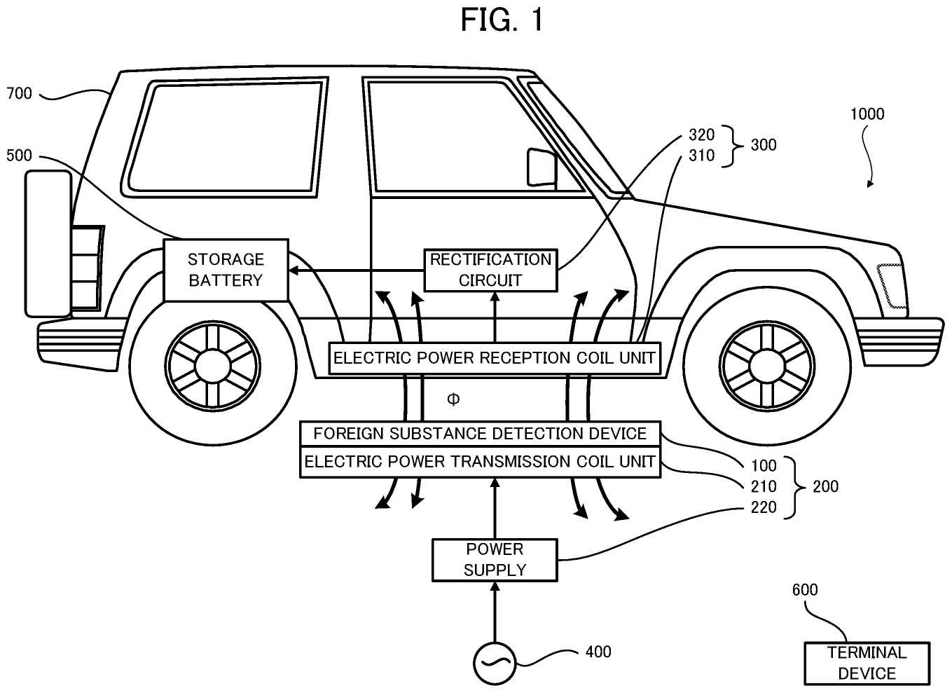

FIG. 1 is a view illustrating the schematic configuration of an electric power transmission system 1000 used in charge of a storage battery 500 included in an electric vehicle 700. The electric vehicle 700 travels using, as a power source, a motor driven by electric power charged in the storage battery 500 such as a lithium-ion battery or a lead storage battery.

As illustrated in FIG. 1, the electric power transmission system 1000 is a system that wirelessly transmits electric power from an electric power transmission device 200 to an electric power reception device 300 by magnetic coupling. The electric power transmission system 1000 includes: the electric power transmission device 200 that wirelessly transmits electric power from an alternating-current or direct-current commercial power source 400 to the electric vehicle 700; and the electric power reception device 300 that receives the electric power transmitted by the electric power transmission device 200 and charges the storage battery 500. In the following discussion, the commercial power source 400 is an alternating-current power source.

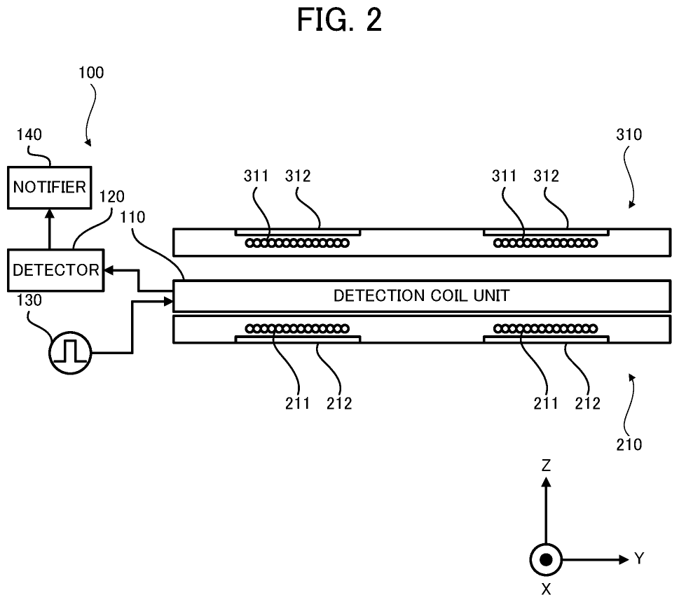

The electric power transmission device 200 is a device that wirelessly transmits electric power to the electric power reception device 300 by magnetic coupling. The electric power transmission device 200 includes: a foreign substance detection device 100 that detects a foreign substance; an electric power transmission coil unit 210 that transmits alternating-current power to the electric vehicle 700; and a power supply 220 that supplies alternating-current power to the electric power transmission coil unit 210. As illustrated in FIG. 2, the foreign substance detection device 100 is arranged on the electric power transmission coil unit 210. In FIG. 2, an upward axis in a vertical direction is the Z-axis, an axis orthogonal to the Z-axis is the X-axis, and an axis orthogonal to the Z-axis and the X-axis is the Y-axis. The details of the foreign substance detection device 100 will be described later.

As illustrated in FIG. 2, the electric power transmission coil unit 210 includes: an electric power transmission coil 211 that induces an alternate magnetic flux 1 in response to supply of alternating-current power the from power supply 220; and a magnetic substance plate 212 through which magnetic force generated by the electric power transmission coil 211 is allowed to pass, to suppress loss of the magnetic force. The electric power transmission coil 211 is formed by spirally winding a conductive wire on the magnetic substance plate 212. The electric power transmission coil 211 and capacitors disposed on both respective ends of the electric power transmission coil 211 form a resonance circuit, which induces an alternate magnetic flux 1 due to flow of alternating current in response to application of alternating voltage.

The magnetic substance plate 212 has the shape of a plate with a central portion in which a hole is opened. The magnetic substance plate 212 is formed of a magnetic substance. The magnetic substance plate 212 is, for example, a plate-shaped member formed of ferrite which is a composite oxide of iron oxide and a metal. The magnetic substance plate 212 may be formed of an aggregate of a plurality of magnetic substance pieces, or may be formed so that the central portion of the magnetic substance plate 212 includes an opening by arranging the plurality of magnetic substance pieces in a frame form.

The power supply 220 includes: a power-factor improvement circuit that improves the power factor of commercial alternating-current power supplied by the commercial power source 400; and an inverter circuit that generates alternating-current power to be supplied to the electric power transmission coil 211. The power-factor improvement circuit rectifies and boosts the alternating-current power generated by the commercial power source 400, and converts the alternating-current power into direct-current power having a predetermined voltage value. The inverter circuit converts, into alternating-current power having a predetermined frequency, the direct-current power generated by converting the electric power by the power-factor improvement circuit. The electric power transmission device 200 is fixed on, for example, the floor surface of a parking place.

The electric power reception device 300 is a device that wirelessly receives electric power from the electric power transmission device 200 by magnetic coupling. The electric power reception device 300 includes: an electric power reception coil unit 310 to receive alternating-current power transmitted by the electric power transmission device 200; and a rectification circuit 320 that converts, into direct-current power, the alternating-current power supplied from the electric power reception coil unit 310, and supplies the direct-current power to the storage battery 500.

As illustrated in FIG. 2, the electric power reception coil unit 310 includes: an electric power reception coil 311 that induces electromotive force in response to change in alternate magnetic flux Φ induced by the electric power transmission coil 211; and a magnetic substance plate 312 through which magnetic force generated by the electric power reception coil 311 is allowed to pass, to suppress loss of the magnetic force. The electric power reception coil 311 and capacitors disposed on both respective ends of the electric power reception coil 311 form a resonance circuit. The electric power reception coil 311 faces the electric power transmission coil 211 in a state in which the electric vehicle 700 stops at a position set in advance. When the electric power transmission coil 211 induces an alternate magnetic flux Φ in response to reception of electric power from the power supply 220, the alternate magnetic flux Φ crosses the electric power reception coil 311, whereby induced electromotive force is induced in the electric power reception coil 311.

The magnetic substance plate 312 has the shape of a plate with a central portion in which a hole is opened. The magnetic substance plate 312 is formed of a magnetic substance. The magnetic substance plate 312 is, for example, a plate-shaped member formed of ferrite which is a composite oxide of iron oxide and a metal. The magnetic substance plate 312 may be formed of an aggregate of a plurality of magnetic substance pieces, or may be formed so that the central portion of the magnetic substance plate 312 includes an opening by arranging the plurality of magnetic substance pieces in a frame form.

The rectification circuit 320 rectifies the electromotive force induced in the electric power reception coil 311, to generate direct-current power. The direct-current power generated by the rectification circuit 320 is supplied to the storage battery 500. The electric power reception device 300 may include a charging circuit that converts direct-current power supplied from the rectification circuit 320, into direct-current power suitable for charging the storage battery 500, between the rectification circuit 320 and the storage battery 500. The electric power reception device 300 is fixed on, for example, the chassis of the electric vehicle 700.

A terminal device 600 is a device that is notified of the presence of a foreign substance from the foreign substance detection device 100. The terminal device 600 is, for example, a smartphone possessed by the owner of the electric vehicle 700. The terminal device 600 notifies a user of the presence of the foreign substance through screen display, voice output, or the like when being notified of the presence of the foreign substance from the foreign substance detection device 100.

The foreign substance detection device 100 detects a foreign substance present in a region for detection. The region for detection is a region for detecting a foreign substance, and is a region in which a foreign substance can be detected. The region for detection is a region in the vicinities of the electric power transmission coil unit 210 and the electric power reception coil unit 310, and is a region including an area between the electric power transmission coil unit 210 and the electric power reception coil unit 310. The foreign substance is an object or living body undesired for transmitting electric power.

The foreign substance may adversely affect transmission of electric power or may result in generation of heat when being arranged in the region for detection in the transmission of electric power. Thus, the foreign substance detection device 100 detects the foreign substance present in the region for detection, and notifies the user of the presence of the foreign substance. When receiving this notification, the user can remove the foreign substance. Possible examples of the foreign substance include various foreign substances such as metal pieces, humans, and animals. As illustrated in FIG. 2, the foreign substance detection device 100 includes a detection coil unit 110, a detector 120, a pulse generator 130, and a notifier 140.

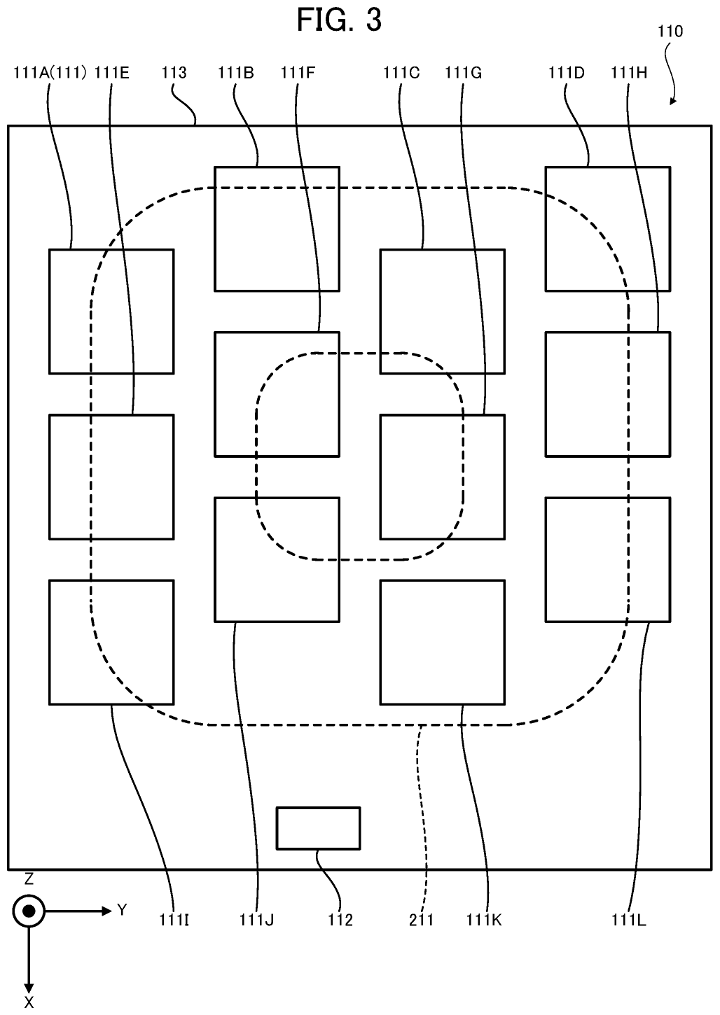

The detection coil unit 110 is a unit that detects a foreign substance. As illustrated in FIG. 3, the detection coil unit 110 is formed in a flat-plate shape, and is arranged on the electric power transmission coil unit 210 so as to overlap the electric power transmission coil 211 in planar view. The detection coil unit 110 includes a detection coil substrate 113 formed of a material with magnetic permeability, of which examples include a resin. The detection coil substrate 113 is provided with: twelve loop coils 111 arranged in a matrix form in the X-axis and Y-axis directions; and an external connection connector 112 through which each loop coil 111, the detector 120, and the pulse generator 130 are connected.

The detector 120 determines whether or not a foreign substance is present in a region for detection on the basis of output values from the loop coils 111 excited by applying pulsing voltage. The pulse generator 130 generates pulsing voltage for detecting a foreign substance, selects a loop coil 111, and applies the pulsing voltage to the loop coil 111. When the foreign substance is detected by the detector 120, the notifier 140 notifies the user of the detection of the foreign substance. For example, the notifier 140 transmits information, representing the detection of the foreign substance, to the terminal device 600 possessed by the user.

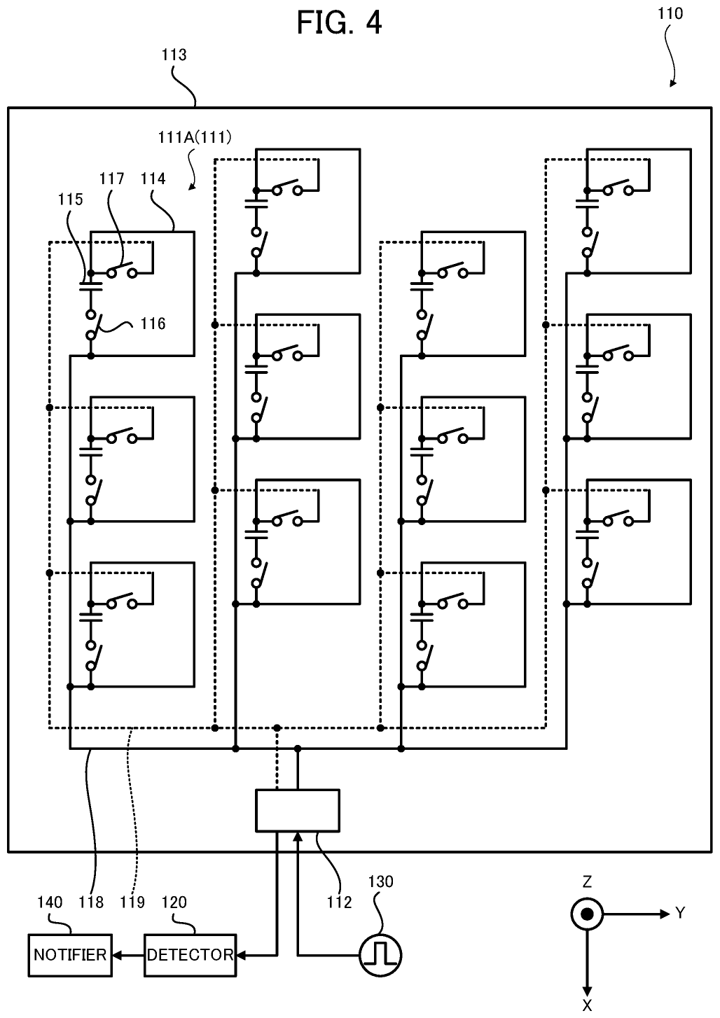

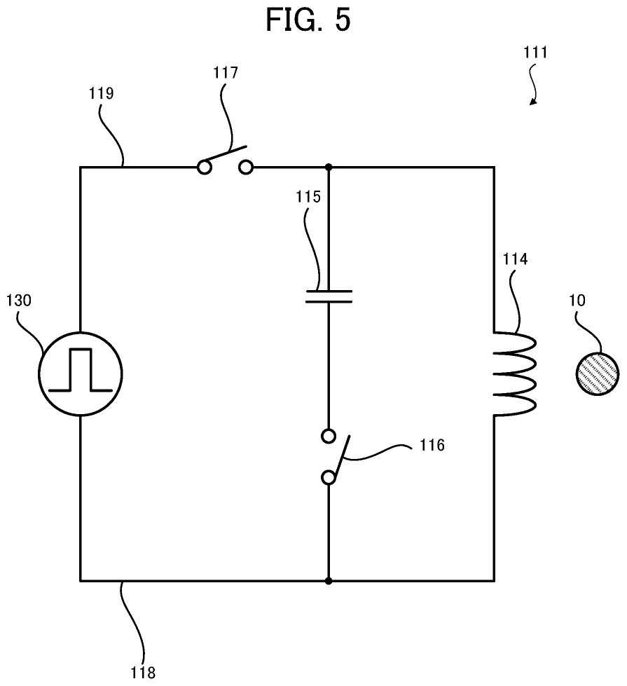

The structure of the loop coil 111 will now be described in detail with reference to FIG. 4 and FIG. 5. The loop coil 111 is the collective term of the twelve loop coils 111 which are a loop coil 111A, a loop coil 111B, a loop coil 111C, a loop coil 111D, a loop coil 111E, a loop coil 111F, a loop coil 111G, a loop coil 111H, a loop coil 111I, a loop coil 111J, a loop coil 111K, and a loop coil 111L. The twelve loop coils 111 have substantially similar structures. The loop coil 111 includes a coil 114, a capacitor 115, a switch 116, and a switch 117. In FIG. 4, only the loop coil 111A is denoted by the reference character in consideration of easiness in seeing of the drawing.

The coil 114 includes a conductor pattern in which winding about an axis parallel to the Z-axis on the upper surface of the detection coil substrate 113 is performed once or a plurality of times. One terminal of the coil 114 is connected to one terminal of the switch 116 and to a first connection wiring line 118. The first connection wiring line 118 is disposed on the upper surface of the detection coil substrate 113, and connected to the external connection connector 112. The other terminal of the coil 114 is connected to one terminal of the capacitor 115 and to one terminal of the switch 117. The other terminal of the switch 117 is connected to a second connection wiring line 119. The other terminal of the capacitor 115 is connected to the other terminal of the switch 116. The second connection wiring line 119 is disposed on the lower surface of the detection coil substrate 113, and connected to the external connection connector 112.

Each of the switch 116 and the switch 117 is controlled in an ON or OFF state under control from the detector 120 through a control line which is not illustrated. The ON state is a conduction state while the OFF state is a non-conduction state. The switch 116 has the function of switching the state between the coil 114 and the capacitor 115. When the switch 116 is turned on, the coil 114 and the capacitor 115 form a resonance circuit. The switch 117 has the function of switching the state between the resonance circuit and the pulse generator 130.

In other words, when both the switch 116 and the switch 117 become in the ON state, the coil 114 and the capacitor 115 form the resonance circuit, and pulsing voltage is applied from the pulse generator 130 to the resonance circuit through the first connection wiring line 118 and the second connection wiring line 119. The voltage between both ends of the resonance circuit, that is, the voltage between both ends of the coil 114 is led to the detector 120 through the first connection wiring line 118 and the second connection wiring line 119. When the switch 116 becomes in the OFF state, the coil 114 and the capacitor 115 do not form any resonance circuit. When the switch 117 becomes in the OFF state, the resonance circuit is electrically disconnected from the first connection wiring line 118 and the second connection wiring line 119, and disconnected from the detector 120 and the pulse generator 130.

FIG. 5 is a view illustrating the equivalent circuit of the resonance circuit formed by the coil 114 and the capacitor 115. FIG. 5 illustrates that a foreign substance 10 is present in the vicinity of the resonance circuit. It is assumed that the switch 117 is closed to apply pulsing voltage from the pulse generator 130 in a state in which the switch 116 is closed to allow the coil 114 and the capacitor 115 to form the resonance circuit. In this case, a voltage signal representing the voltage between both ends of the resonance circuit is an oscillating signal of which the peak value is gradually attenuated with passage of time.

The presence of the foreign substance 10 in the vicinity of the coil 114 results in change in the inductance of the coil 114. Therefore, the presence of the foreign substance 10 results in change in the frequency of the oscillating signal or in change in the degree of the attenuation of the oscillating signal, in comparison with the absence of the foreign substance 10. The detector 120 determines the presence or absence of the foreign substance 10 by detecting the change in the frequency of the oscillating signal, the change in the degree of the attenuation of the oscillating signal, or the like.

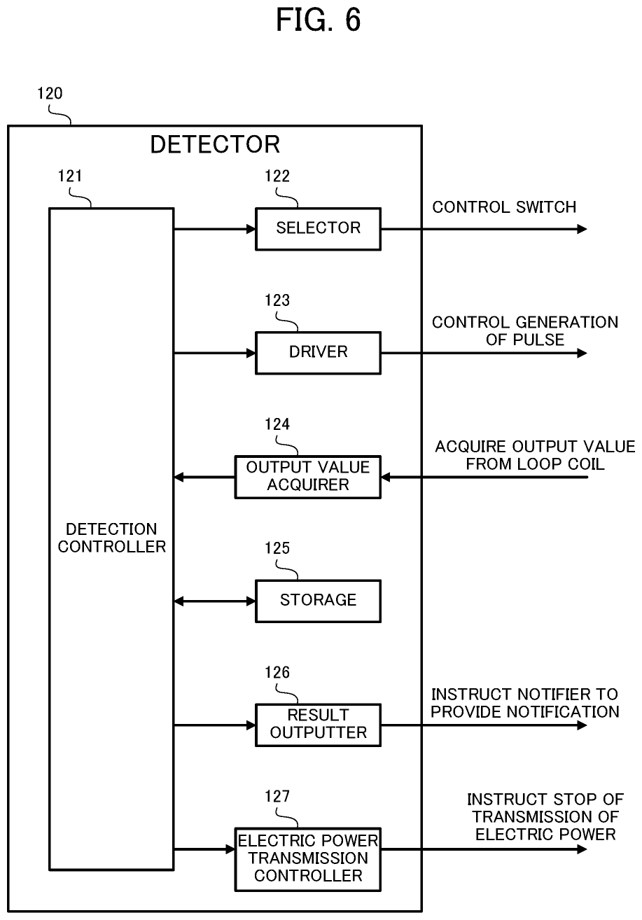

The structure of the detector 120 is illustrated in FIG. 6. The detector 120 is implemented, for example, by a computer including a central processing unit (CPU), a memory, an analog/digital (A/D) converter, and the like, and by an operation program. The detector 120 functionally includes a detection controller 121, a selector 122, a driver 123, an output value acquirer 124, a storage 125, a result outputter 126, and an electric power transmission controller 127.

The detector 120 uses these components, to select any one of the twelve loop coils 111, to allow the switch 116 and switch 117 of the selected loop coil 111 to be in an ON state, to allow the switches 116 and switches 117 of the unselected loop coils 111 to be in an OFF state, and to detect the presence or absence of the foreign substance 10 in the vicinity of the selected loop coil 111. The detector 120 in turn executes detection of the presence or absence of such a foreign substance for all of the twelve loop coils 111, and outputs the results of the detection.

The detection controller 121 controls each component included in the detector 120, and executes the detection of the foreign substance 10, the output of the detection results, and the like. The selector 122 selects any of the twelve loop coils 111 under the control by the detection controller 121, and controls, in an ON state, the switch 116 and the switch 117 included in the selected loop coil 111. After the execution of the selection and the ON-control by the selector 122, the driver 123 drives the pulse generator 130 under the control by the detection controller 121, to singly generate pulsing voltage in the pulse generator 130.

The pulsing voltage is applied to the resonance circuit, formed in the selected loop coil 111, through the external connection connector 112, the first connection wiring line 118, the second connection wiring line 119, and the like. The voltage between both ends of the resonance circuit is led to the output value acquirer 124 through the external connection connector 112, the first connection wiring line 118, the second connection wiring line 119, and the like.

The output value acquirer 124 acquires an output value from the selected loop coil 111 from the oscillating signal representing the voltage between both ends of the resonance circuit under the control by the detection controller 121. The kind of a value at which the output value acquired by the output value acquirer 124 is set can be adjusted as appropriate. For example, the output value can be set at the frequency of the oscillating signal, the convergence time of the oscillating signal, the magnitude of the amplitude of the oscillating signal, or the like. The convergence time of the oscillating signal is, for example, time between the application of the pulsing voltage and the convergence of the amplitude of the oscillating signal to a level that is not more than a predetermined amplitude. The magnitude of the amplitude of the oscillating signal is, for example, the magnitude of the amplitude of the oscillating signal at a lapse of predetermined time after the application of the pulsing voltage.

The storage 125 stores various data on a foreign substance detection process executed by the foreign substance detection device 100. For example, the storage 125 stores an output value, a reference value, a difference value, a first threshold value, a second threshold value, the first number of times of excess, the second number of times of excess, the first number of times, and the second number of times. The output value is an output value acquired by the output value acquirer 124. The reference value is a reference value for the output value. In other words, the reference value is an output value acquired when the foreign substance 10 is absent in the vicinities of the loop coils 111. The reference value, acquired in advance by an experiment, a simulation, or the like, is stored in the storage 125.

The difference value is the value of a difference between the reference value which is an output value acquired when the foreign substance 10 is absent and the currently acquired output value. In other words, the difference value is the amount of change from the output value acquired when the foreign substance 10 is absent. The low difference value means that the foreign substance 10 is highly likely to be absent, while the high difference value means that the foreign substance 10 is highly likely to be present. The first threshold value and the second threshold value are threshold values for determining the difference value. The second threshold value is a higher value than the first threshold value. The first threshold value and the second threshold value are set in advance in consideration of, for example, the magnitude of predicted noise, the degree of change in the output value depending on the presence or absence of the foreign substance 10, and the like, and are stored in the storage 125.

The first number of times of excess is the number of times at which the difference value exceeds the first threshold value. The first number of times of excess is incremented by 1 or reset to 0 whenever the output value is acquired. For example, when the difference value between the acquired output value and the reference value exceeds the first threshold value, the first number of times of excess is incremented by 1. In contrast, when the difference value between the acquired output value and the reference value does not exceed the first threshold value, the first number of times of excess is reset to 0. The second number of times of excess is the number of times at which the difference value exceeds the second threshold value. The second number of times of excess is incremented by 1 or reset to 0 whenever the output value is acquired. For example, when the difference value between the acquired output value and the reference value exceeds the second threshold value, the second number of times of excess is incremented by 1. In contrast, when the difference value between the acquired output value and the reference value does not exceed the second threshold value, the second number of times of excess is reset to 0. When the difference value between the output value and the reference value exceeds the second threshold value, the difference value also exceeds the first threshold value, and therefore, the first number of times of excess is also incremented by 1.

The first number of times is a threshold value for determining the first number of times of excess. When the first number of times of excess reaches the first number of times, the presence of the foreign substance 10 is determined. The second number of times is a threshold value for determining the second number of times of excess. When the second number of times of excess reaches the second number of times, the presence of the foreign substance 10 is determined. The second number of times is less than the first number of times. The second number of times is preferably 2 or more, and the first number of times is preferably 3 or more. The first number of times and the second number of times, set in advance in consideration of, for example, the easiness of occurrence of noise, the magnitude of the risk of the presence of the foreign substance 10, and the like, are stored in the storage 125.

In the present embodiment, the reference value, the first threshold value, the second threshold value, the first number of times, and the second number of times are shared in the twelve loop coils 111. In contrast, such output values, difference values, first numbers of times of excess, and second numbers of times of excess are prepared for the twelve loop coils 111, respectively. In other words, the first number of times of excess is the cumulative number of times at which the difference value between the output and reference values of one loop coil 111 of the twelve loop coils 111 exceeds the first threshold value, while the second number of times of excess is the cumulative number of times at which the difference value between the output and reference values of one loop coil 111 of the twelve loop coils 111 exceeds the second threshold value.

The detection controller 121 determines the presence or absence of the foreign substance 10 on the basis of the results of comparison between a value for comparison, based on the output value from the loop coil 111, and the threshold values. The value for comparison, which is a value for comparison with the threshold values, is specifically the difference value between the output value and the reference value, or a value based on the difference value. In the present embodiment, the value for comparison is the difference value between the output value and the reference value. In other words, in the present embodiment, the detection controller 121 determines the presence or absence of the foreign substance 10 on the basis of the results of the comparison between the difference value between the output value from the loop coil 111 and the reference value, and the threshold values including the first threshold value and the second threshold value which is more than the first threshold value. Specifically, the detection controller 121 determines the presence of the foreign substance 10 when the number of times at which the difference value exceeds the first threshold value reaches the first number of times.

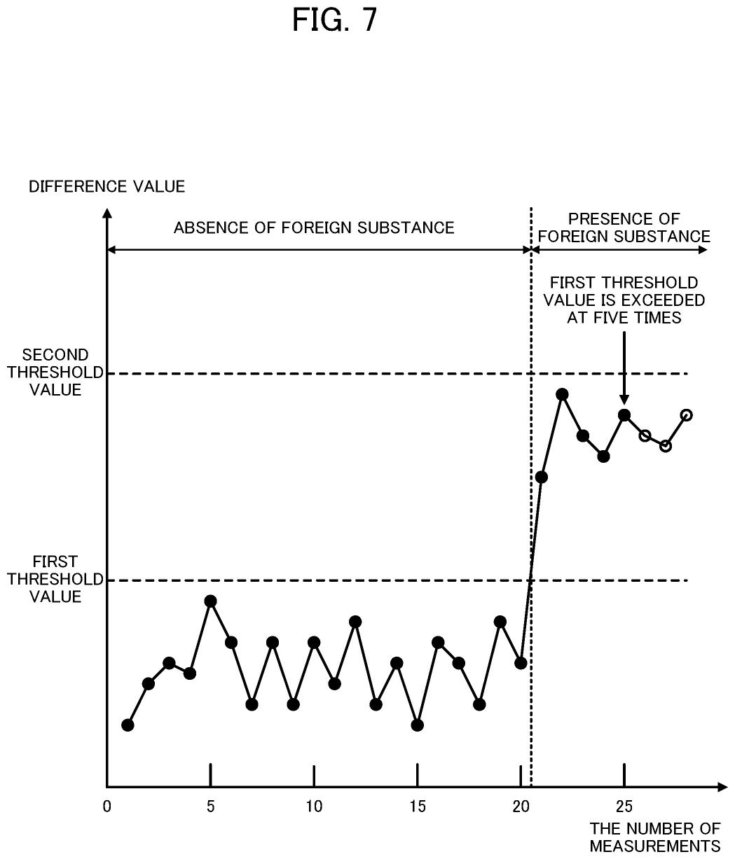

An example in which the difference value consecutively exceeds the first threshold value at not less than the first number of times, whereby the presence of the foreign substance 10 is determined, will be described below with reference to FIG. 7. A first graph indicating a correspondence relationship between the number of measurements and the difference value is illustrated in FIG. 7. The first graph represents a situation in which difference values between the first measurement and the 20th measurement do not exceed the first threshold value but difference values at the 21st and later measurements exceed the first threshold value. In such a case, the detection controller 121 determines the presence of the foreign substance 10 at the time of the completion of the 25th measurement when the first number of times is 5.

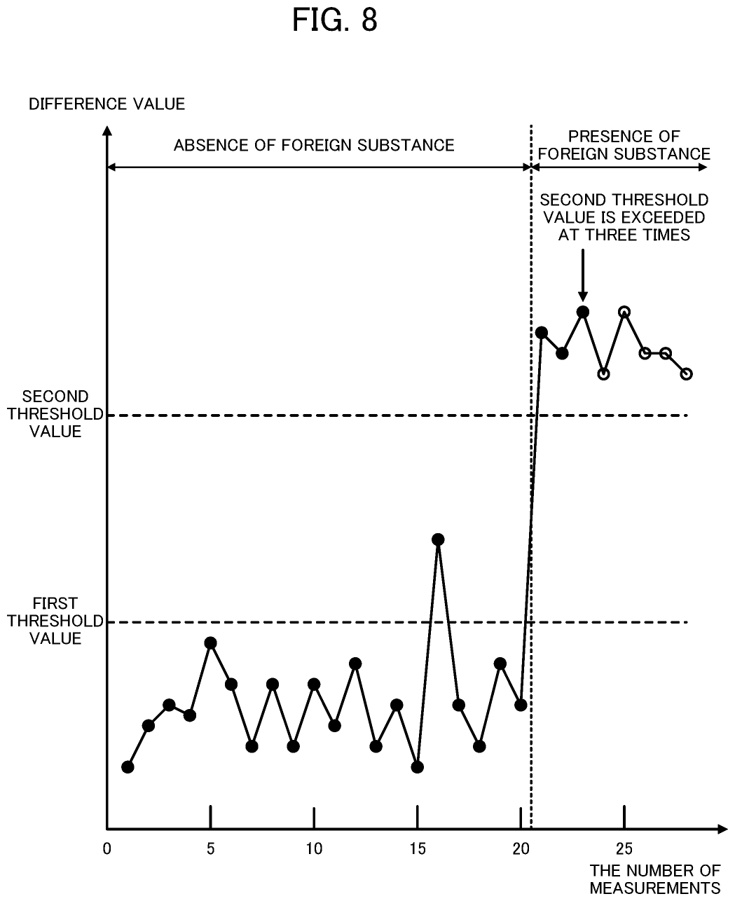

The detection controller 121 determines the presence of the foreign substance 10 when the number of times at which the difference value exceeds the second threshold value reaches the second number of times, which is less than the first number of times. An example in which the difference value consecutively exceeds the second threshold value at not less than the second number of times, whereby the presence of the foreign substance 10 is determined, will be described below with reference to FIG. 8. A second graph indicating a correspondence relationship between the number of measurements and the difference value is illustrated in FIG. 8. The second graph represents a situation in which difference values between the first measurement and the 20th measurement do not exceed the second threshold value but difference values at the 21st and later measurements exceed the second threshold value. In such a case, the detection controller 121 determines the presence of the foreign substance 10 at the time of the completion of the 23rd measurement when the second number of times is 3. The second graph indicates that the difference value exceeds the first threshold value at the 16th measurement. However, the detection controller 121 does not determine the presence of the foreign substance 10 only on the basis of the fact that the difference value exceeds the first threshold value once.

The fact that the difference value exceeds the first threshold value means that the foreign substance 10 is highly likely to be present. The fact that the difference value exceeds the second threshold value means, for example, that the foreign substance 10 is very highly likely to be present, that the foreign substance 10 is highly likely to be in the immediate vicinity of the detection coil unit 110, that the foreign substance 10 that greatly influence transmission of electric power is highly likely to be present, and that the foreign substance 10 that is prone to generate heat is highly likely to be present. In other words, it is considered that it is desired to more immediately complete the detection and notification of the foreign substance 10 in a case in which the difference value exceeds the second threshold value than in a case in which the difference value exceeds the first threshold value but does not exceed the second threshold value. Thus, the second number of times is set at the number of times that is less than the first number of times.

Moreover, the detection controller 121 repeatedly executes a consecutive comparison process. The consecutive comparison process is a process of executing individual comparison processes of the twelve loop coils 111 in predetermined order. Such an individual comparison process is a process in which the difference value which is a value for comparison and the threshold values are compared for one loop coil 111. For example, the consecutive comparison process is a process of executing the individual comparison processes in execution order (hereinafter referred to, as appropriate, as “initial execution order”) of the loop coil 111A, the loop coil 111B, the loop coil 111C, the loop coil 111D, the loop coil 111E, the loop coil 111F, the loop coil 111G, the loop coil 111H, the loop coil 111I, the loop coil 111J, the loop coil 111K, and the loop coil 111L. In other words, in the consecutive comparison process, the individual comparison processes are executed in order of the loop coil 111A, the loop coil 111B, . . . , the loop coil 111L, the loop coil 111A, the loop coil 111B, . . . .

The result outputter 126 outputs the detection results from the detection controller 121 under the control by the detection controller 121. For example, when the presence of the foreign substance 10 is determined by the detection controller 121, the result outputter 126 instructs the notifier 140 to provide notification that the foreign substance 10 is present. The notifier 140 transmits information, representing the detection of the foreign substance, to the terminal device 600 possessed by the user when receiving the notification from the detection controller 121. The terminal device 600 notifies the user of the detection of the foreign substance through screen display, voice output, or the like.

The electric power transmission controller 127 controls transmission of electric power to the electric power reception coil unit 310 by the electric power transmission coil unit 210 under the control by the detection controller 121. When the detection controller 121 determines the presence of the foreign substance 10, the electric power transmission controller 127 instructs the power supply 220 to stop the transmission of the electric power.

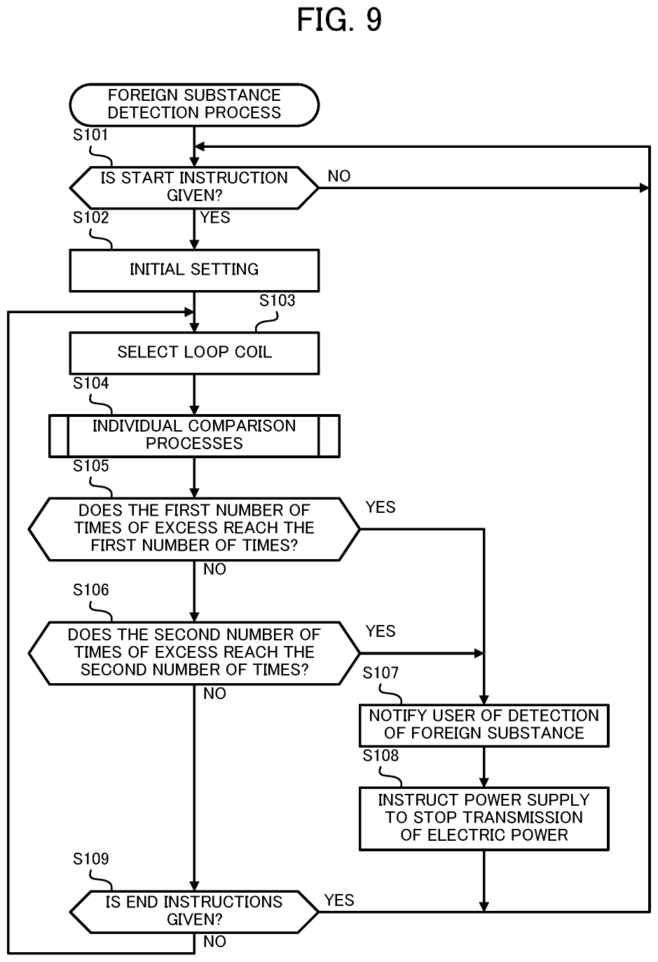

The foreign substance detection process executed by the foreign substance detection device 100 will now be described with reference to FIG. 9. The foreign substance detection process is started, for example, at power-up of the foreign substance detection device 100.

First, the detector 120 included in the foreign substance detection device 100 determines whether or not an instruction to start the foreign substance detection process is given (step S101). For example, the detector 120 determines that the instruction to start the foreign substance detection process is given when the foreign substance detection device 100 is notified of the start of the transmission of the electric power from the power supply 220. When determining that the instruction to start the foreign substance detection process is given (step S101: YES), the detector 120 executes an initial setting (step S102). The initial setting is an initial setting for the foreign substance detection process. In the initial setting, for example, the switch 116 and the switch 117 included in the detection coil unit 110 are set in an OFF state, and the first number of times of excess and the second number of times of excess are reset to 0.

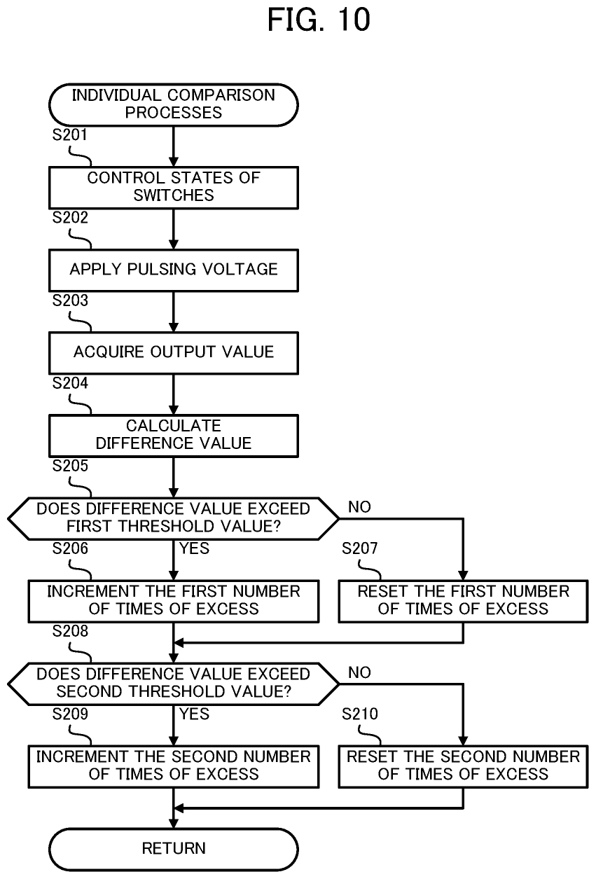

When completing the process of step S102, the detector 120 selects the loop coil 111 (step S103). For example, the detector 120 selects one loop coil 111 from the twelve loop coils 111 in predetermined order. When completing the process of step S103, the detector 120 executes an individual comparison process of the selected loop coil 111 (step S104). The individual comparison process will be described in detail with reference to FIG. 10.

First, the detector 120 controls the states of the switch 116 and the switch 117 (step S201). In other words, the detector 120 controls the switch 116 and the switch 117, included in the selected loop coil 111, in ON states, and controls the switches 116 and the switches 117, included in the unselected loop coils 111, in OFF states. When completing the process of step S201, the detector 120 applies pulsing voltage to the selected loop coil 111 (step S202). In other words, the detector 120 controls the pulse generator 130 to generate the pulsing voltage.

When completing the process of step S202, the detector 120 acquires an output value from the selected loop coil 111 (step S203). When completing the process of step S203, the detector 120 calculates a difference value from the acquired output value and the reference value (step S204). When completing the process of step S204, the detector 120 determines whether or not the difference value exceeds the first threshold value (step S205).

When determining that the difference value exceeds the first threshold value (step S205: YES), the detector 120 increments the first number of times of excess (step S206). In other words, the detector 120 increments the first number of times of excess by 1. When determining that the difference value does not exceed the first threshold value (step S205: NO), the detector 120 resets the first number of times of excess (step S207). In other words, the detector 120 sets the first number of times of excess to 0. When completing the process of step S206 or step S207, the detector 120 determines whether or not the difference value exceeds the second threshold value (step S208).

When determining that the difference value exceeds the second threshold value (step S208: YES), the detector 120 increments the second number of times of excess (step S209). When determining that the difference value does not exceed the second threshold value (step S208: NO), the detector 120 resets the second number of times of excess (step S210). When completing the process of step S209 or step S210, the detector 120 completes the individual comparison process.

When completing the individual comparison process of step S104, the detector 120 determines whether or not the first number of times of excess reaches the first number of times (step S105). When determining that the first number of times of excess does not reach the first number of times (step S105: NO), the detector 120 determines whether or not the second number of times of excess reaches the second number of times (step S106). When determining that the first number of times of excess reaches the first number of times (step S105: YES) or determining that the second number of times of excess reaches the second number of times (step S106: YES), the detector 120 notifies the user of the detection of the foreign substance (step S107). The process of determining whether or not the second number of times of excess reaches the second number of times (process of step S106) may also be carried out before the process of determining whether or not the first number of times of excess reaches the first number of times (process of step S105).

For example, the detector 120 instructs the notifier 140 to provide notification. The notifier 140 transmits information, representing the detection of the foreign substance 10, to the terminal device 600 according to the instruction by the detector 120. When receiving the information, the terminal device 600 notifies the user of the detection of the foreign substance 10 through screen display, voice output, or the like. When receiving the notification of the presence of the foreign substance 10 from the terminal device 600, the user removes the foreign substance 10.

When completing the process of step S107, the detector 120 instructs the power supply 220 to stop the transmission of the electric power (step S108). For example, the detector 120 transmits information for instructing the power supply 220 to stop the transmission of the electric power. When receiving the information, the power supply 220 stops the transmission of the electric power. The process of instructing the power supply 220 to stop the transmission of the electric power (process of step S108) may also be carried out before the process of notifying the user of the detection of the foreign substance (process of step S107).

When determining that the second number of times of excess does not reach the second number of times (step S106: NO), the detector 120 determines whether or not an instruction to end the foreign substance detection process (step S109). For example, when the foreign substance detection device 100 is notified of the end of the transmission of the electric power from the power supply 220, the detector 120 determines that the instruction to end the foreign substance detection process is given. When the detector 120 determines that the instruction to start the foreign substance detection process is not given (step S101: NO), the process of step S108 is completed, or the detector 120 determines that the instruction to end the foreign substance detection process is given (step S109: YES), the detector 120 returns the process to step S101. When determining that the instruction to end the foreign substance detection process is not given (step S109: NO), the detector 120 returns the process to step S103.

In the present embodiment, the presence of the foreign substance is determined in cases in which the number of times at which the difference value between the output value which is the value for comparison and the reference value exceeds the first threshold value reaches the first number of times, and the number of times at which the difference value exceeds the second threshold value reaches the second number of times which is less than the first number of times. Accordingly, the foreign substance 10 can be immediately detected with high precision in accordance with the present embodiment. More specifically, in accordance with the present embodiment, a speed at which the specific foreign substance 10 is detected can be improved while suppressing false detection.

In other words, when a state in which the output value differs, but does not greatly differ, from the reference value is detected, the presence of the foreign substance 10 is determined in a case in which the state continues for relatively long time. In this case, false detection is considered to less frequently occur because the first number of times is more than the second number of times. Accordingly, notification that the foreign substance 10 is present is accurately provided when it is expected that adverse effect on transmission of electric power is not so great, and the amount of generated heat is not so large.

When a state in which the output value differs greatly from the reference value is detected, the presence of the foreign substance 10 is determined in a case in which the state continues even for relatively short time. Accordingly, notification that the foreign substance 10 is present is immediately provided when it is expected that adverse effect on transmission of electric power is great, and the amount of generated heat is large. In this case, false detection is considered to less frequently occur because the second number of times is 2 or more. As described above, the second threshold value and the second number of times are used for detecting the specific foreign substance 10 which is considered to result in the great adverse effect on transmission of electric power and in the large amount of generated heat.

### Embodiment 2

Embodiment 1 describes the example in which the individual comparison processes are executed in unchanged order even when the difference value exceeds the second threshold value in any loop coil 111. Embodiment 2 describes an example in which individual comparison processes are executed in changed order when a difference value exceeds a second threshold value in any loop coil 111. Description of structures and processes similar to those in Embodiment 1 will be omitted or simplified.

In the present embodiment, a detector 120 also executes a consecutive comparison process in which individual comparison processes of each comparing a difference value which is a value for comparison and threshold values for one loop coil 111 are executed for a plurality of loop coils 111 in predetermined order. In such a case, when the difference value in a first loop coil among the plurality of loop coils 111 exceeds a second threshold value in the execution of the consecutive comparison process, the detector 120 consecutively executes an individual comparison process for the first loop coil. In the present embodiment, individual comparison processes for the first loop coil are consecutively executed at the predetermined specified number of times when the difference value in the first loop coil exceeds the second threshold value.

For example, when consecutive comparison processes of execution in initial execution order of a loop coil 111A, a loop coil 111B, . . . , and loop coil 111L are repeatedly executed, a case is considered in which the difference value in the loop coil 111C exceeds the second threshold value in the N-th consecutive comparison process. In this case, individual comparison processes for the loop coil 111C are consecutively executed after the execution of an individual comparison process for the loop coil 111C in the N-th consecutive comparison process.

In other words, the individual comparison processes are executed in order of the loop coil 111A, the loop coil 111B, the loop coil 111C, the loop coil 111C, the loop coil 111C, the loop coil 111C, the loop coil 111C, . . . , from the beginning of the N-th consecutive comparison process. The specified number of times at which the individual comparison processes consecutively executed can be adjusted as appropriate. For example, the specified number of times at which the individual comparison processes, including the individual comparison process in which the difference value first exceeds the second threshold value, are executed is preferably 2 or more.

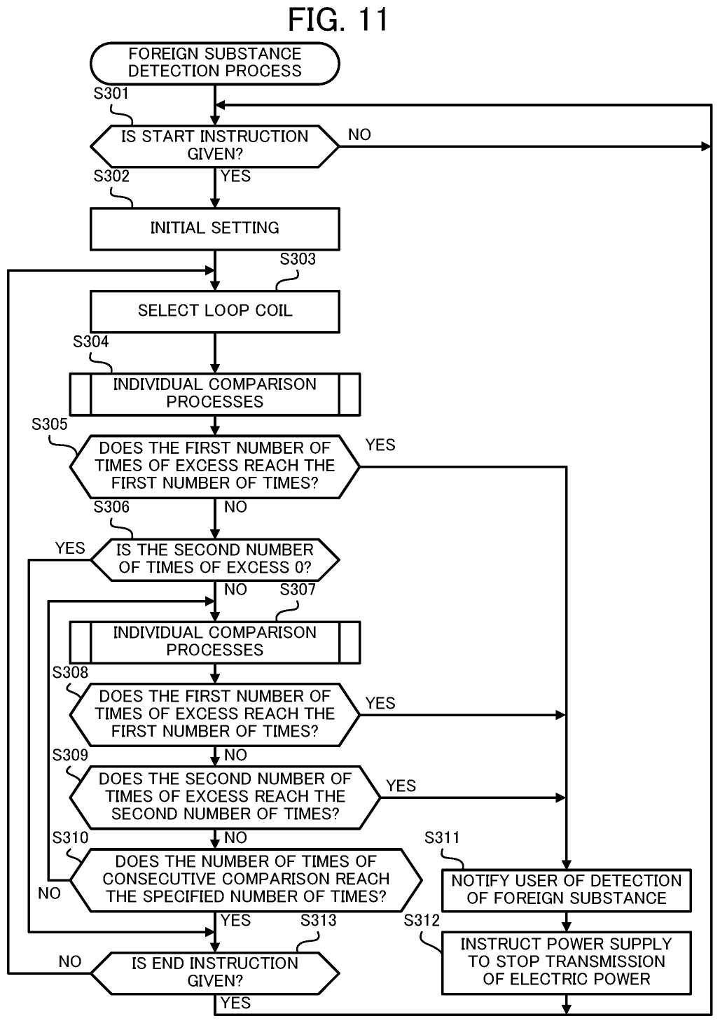

A foreign substance detection process executed by a foreign substance detection device 100 will now be described with reference to FIG. 11.

First, the detector 120 determines whether or not an instruction to start the foreign substance detection process is given (step S301). When determining that the instruction to start the foreign substance detection process is given (step S301: YES), the detector 120 executes an initial setting (step S302). When completing the process of step S302, the detector 120 selects a loop coil 111 (step S303). For example, the detector 120 selects the loop coils 111 in order of the loop coil 111A, the loop coil 111B, the loop coil 111C, . . . , the loop coil 111L, the loop coil 111A, the loop coil 111B, . . . .

When completing the individual comparison process of step S304, the detector 120 determines whether or not the first number of times of excess reaches the first number of times (step S305). When determining that the first number of times of excess does not reach the first number of times (step S305: NO), the detector 120 determines whether or not the second number of times of excess is 0 (step S306). When determining that the second number of times of excess is not 0 (step S306: NO), the detector 120 executes the individual comparison process for the currently selected loop coil 111 (step S307).

When completing the process of step S307, the detector 120 determines whether or not the first number of times of excess reaches the first number of times (step S308). When determining that the first number of times of excess does not reach the first number of times (step S308: NO), the detector 120 determines whether or not the second number of times of excess reaches the second number of times (step S309). When determining that the second number of times of excess does not reach the second number of times (step S309: NO), the detector 120 determines whether or not the number of times of consecutive comparison reaches the specified number of times (step S310). The process of determining whether or not the second number of times of excess reaches the second number of times (process of step S309) may also be carried out before the process of determining whether or not the first number of times of excess reaches the first number of times (process of step S308).

The number of times of consecutive comparison is the number of times of individual comparison processes consecutively executed for a loop coil 111 in which the difference value exceeds the second threshold value. The number of times of consecutive comparison is incremented by 1 whenever an individual comparison process is executed. When determining that the number of times of consecutive comparison does not reach the specified number of times (step S310: NO), the detector 120 returns the process to step S307.

When determining that the first number of times of excess reaches the first number of times (step S305: YES), determining that the first number of times of excess reaches the first number of times (step S308: YES), or determining that the second number of times of excess reaches the second number of times (step S309: YES), the detector 120 notifies a user of detection of a foreign substance (step S311). When completing the process of step S311, the detector 120 instructs a power supply 220 to stop transmission of electric power (step S312). The process of instructing the power supply 220 to stop the transmission of the electric power (process of step S312) may also be carried out before the process of notifying the user of the detection of the foreign substance (process of step S311).

When determining that the second number of times of excess is 0 (step S306: YES) or determining that the number of times of consecutive comparison reaches the specified number of times (step S310: YES), the detector 120 determines whether or not an instruction to end the foreign substance detection process is given (step S313). When determining that the instruction to start the foreign substance detection process is not given (step S301: NO), completing the process of step S312, or determining that the instruction to end the foreign substance detection process is given (step S313: YES), the detector 120 returns the process to step S301. When determining that the instruction to end the foreign substance detection process is not given (step S313: NO), the detector 120 returns the process to step S303.

In the present embodiment, the individual comparison processes for the first loop coil are consecutively executed at the predetermined specified number of times when the difference value in the first loop coil among the plurality of loop coils 111 exceeds the second threshold value in the execution of the consecutive comparison process. Accordingly, the result of detection of a foreign substance 10 in a region in which the foreign substance 10 is highly likely to be present can be immediately acquired in accordance with the present embodiment.

### Embodiment 3

Embodiment 2 describes the example in which the individual comparison processes for the first loop coil are consecutively executed when the difference value in the first loop coil exceeds the second threshold value in the execution of the consecutive comparison processes. Embodiment 3 describes an example in which individual comparison processes for a first loop coil are executed in changed order in consecutive comparison processes when a difference value in the first loop coil exceeds a second threshold value in execution of the consecutive comparison processes. Description of structures and processes similar to those in Embodiments 1 and 2 will be omitted or simplified.

In the present embodiment, a detector 120 repeatedly executes consecutive comparison processes in which individual comparison processes of each comparing a difference value which is a value for comparison and threshold values for one loop coil 111 are executed for a plurality of loop coils 111 in predetermined order. When the difference value in the first loop coil among the plurality of loop coils 111 exceeds the second threshold value in the execution of one of the consecutive comparison processes, the detector 120 executes an individual comparison process for the first loop coil in earlier order in the consecutive comparison process, and then executes the subsequent consecutive comparison processes.

For example, when consecutive comparison processes of execution in initial execution order of a loop coil 111A, a loop coil 111B, . . . , and loop coil 111L are repeatedly executed, a case is considered in which the difference value in the loop coil 111C exceeds the second threshold value in the N-th consecutive comparison process. In this case, the order in which the individual comparison processes are executed in the consecutive comparison processes is changed so that the individual comparison process for the loop coil 111C is executed in the earliest order. Thus, the (N+1)th and later consecutive comparison processes are repeatedly executed.

In other words, the individual comparison processes are executed in order of the loop coil 111A, the loop coil 111B, the loop coil 111C, the loop coil 111D, . . . , the loop coil 111L, the loop coil 111C, the loop coil 111A, the loop coil 111B, the loop coil 111D, . . . , the loop coil 111L, the loop coil 111C, the loop coil 111A, the loop coil 111B, the loop coil 111D, . . . , the loop coil 111L, . . . , from the beginning of the N-th consecutive comparison process. Timing until which the changed order of the execution is maintained can be adjusted as appropriate. For example, the changed order of the execution may be maintained until the consecutive comparison processes are executed at the specified number of times after the change of the order of the execution. Alternatively, the changed order of the execution may be maintained until the difference value for another loop coil 111 exceeds the second threshold value.

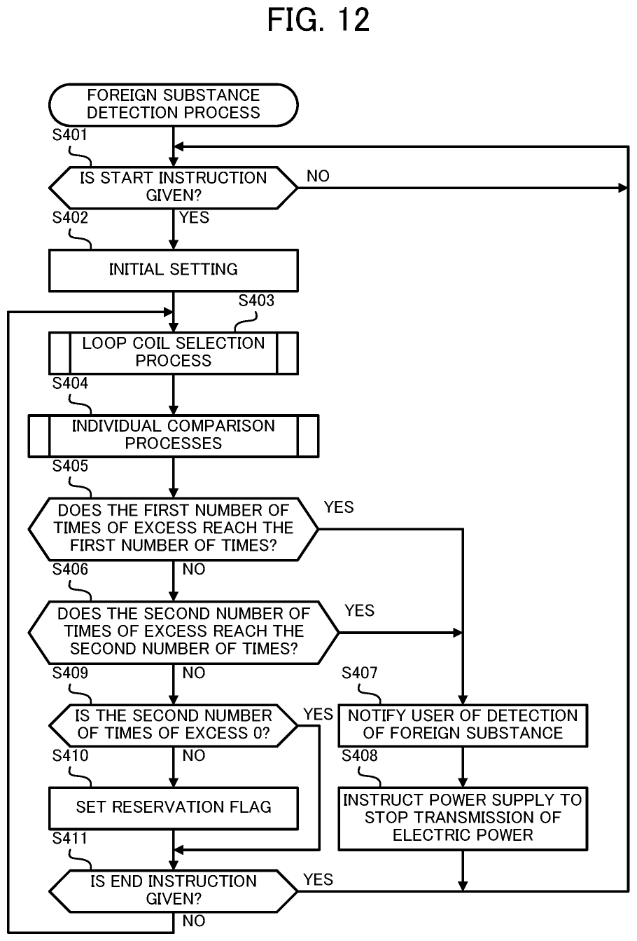

A foreign substance detection process executed by a foreign substance detection device 100 will now be described with reference to FIG. 12.

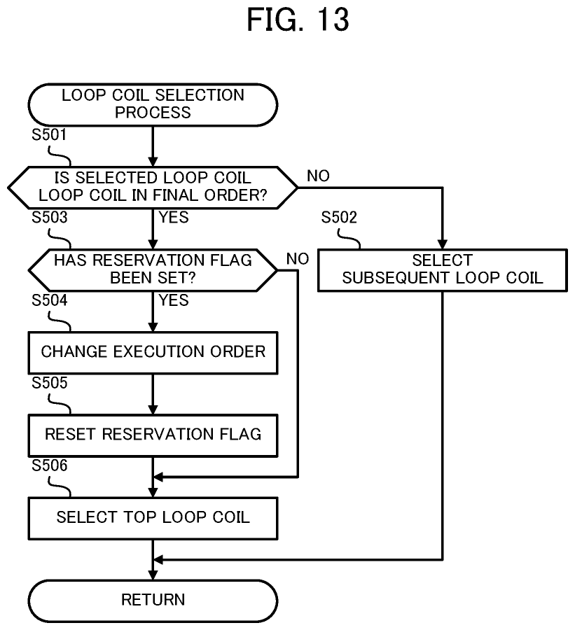

First, the detector 120 determines whether or not an instruction to start the foreign substance detection process is given (step S401). When determining that the instruction to start the foreign substance detection process is given (step S401: YES), the detector 120 executes an initial setting (step S402). When completing the process of step S402, the detector 120 executes a loop coil selection process (step S403). The loop coil selection process will be described in detail with reference to FIG. 13.

First, the detector 120 determines whether or not the selected loop coil 111 is a loop coil 111 in the final order (step S501). The loop coil 111 in the final order is a loop coil 111 in which an individual comparison process is finally executed in current execution order. When the current execution order is initial execution order, the loop coil 111 in the final order is the loop coil 111L. When determining that the selected loop coil 111 is not the loop coil 111 in the final order (step S501: NO), the detector 120 selects the subsequent loop coil 111 (step S502).

When determining that the selected loop coil 111 is the loop coil 111 in the final order (step S501: YES), the detector 120 determines whether or not a reservation flag has been set (step S503). The reservation flag is a flag for making a reservation for changing execution order, and is prepared for each of the loop coils 111. When determining that the reservation flag has been set (step S503: YES), the detector 120 changes the execution order (step S504).

For example, the detector 120 changes the execution order so that a loop coil 111 in which a reservation flag has been set is first executed. For example, when reservation flags have been set in the loop coil 111C and the loop coil 111D, the execution order is changed to order of the loop coil 111C, the loop coil 111D, the loop coil 111A, the loop coil 111B, the loop coil 111E, . . . , and the loop coil 111L.

When completing the process of step S504, the detector 120 resets the reservation flag (step S505). When determining that the reservation flag has not been set (step S503: NO), or completing the process of step S505, the detector 120 selects the top loop coil 111 (step S506). When completing the process of step S502 or step S506, the detector 120 completes the loop coil selection process. When completing the loop coil selection process of step S403, the detector 120 executes individual comparison processes (step S404).

When completing the individual comparison processes of step S404, the detector 120 determines whether or not the first number of times of excess reaches the first number of times (step S405). When determining that the first number of times of excess does not reach the first number of times (step S405: NO), the detector 120 determines whether or not the second number of times of excess reaches the second number of times (step S406). When determining that the first number of times of excess reaches the first number of times (step S405: YES) or determining that the second number of times of excess reaches the second number of times (step S406: YES), the detector 120 notifies a user of detection of a foreign substance (step S407). When completing the process of step S407, the detector 120 instructs a power supply 220 to stop transmission of electric power (step S408). The process of instructing the power supply 220 to stop the transmission of the electric power (process of step S408) may also be carried out before the process of notifying the user of the detection of the foreign substance (process of step S407). The process of determining whether that the second number of times of excess reaches the second number of times (process of step S406) may also be carried out before the process of determining whether or not the first number of times of excess reaches the first number of times (process of step S405).

When determining that the second number of times of excess does not exceed the second number of times (step S406: NO), the detector 120 determines whether or not the second number of times of excess is 0 (step S409). When determining that the second number of times of excess is not 0 (step S409: NO), the detector 120 sets the reservation flag (step S410). The detector 120 sets the reservation flag in the currently selected loop coil 111.

When determining that the second number of times of excess is 0 (step S409: YES), or completing the process of step S410, the detector 120 determines whether or not an instruction to end the foreign substance detection process is given (step S411). When determining that the instruction to start the foreign substance detection process is not given (step S401: NO), completing the process of step S408, or determining that the instruction to end the foreign substance detection process is given (step S411: YES), the detector 120 returns the process to step S401. When determining that the instruction to end the foreign substance detection process is not given (step S411: NO), the detector 120 returns the process to step S403.

In the present embodiment, when the difference value in the first loop coil among the plurality of loop coils 111 exceeds the second threshold value in the execution of one of the consecutive comparison processes, the individual comparison process for the first loop coil is executed in earlier order in the consecutive comparison process, and the subsequent consecutive comparison processes are then executed. Accordingly, the result of detection of a foreign substance 10 in a region in which the foreign substance 10 is highly likely to be present can be earlier acquired than the result of the detection of the foreign substance 10 in another region, in accordance with the present embodiment.

### Embodiment 4

Embodiments 1 to 3 describe the examples in which the second numbers of times for all the loop coils 111 are identical. Embodiment 4 describes an example in which the number of times varying depending on a position at which a loop coil 111 is arranged is used as the second number of times. Description of structures and processes similar to those in Embodiments 1 to 3 will be omitted or simplified.

In the present embodiment, a plurality of loop coils 111 is arranged to cover an electric power transmission coil 211. A detector 120 uses the number of times, varying depending on a position at which each of the plurality of loop coils 111 is arranged, as the second number of times. For example, the third number of times, which is less than the fourth number of times, or the fourth number of times is prepared as the second number of times. The detector 120 uses the third number of times as the second number of times for a loop coil 111 arranged in a first region. The detector 120 uses the fourth number of times as the second number of times for a loop coil 111 arranged in a second region.

The first region is a region in which a foreign substance 10 is desired to be more quickly detected than the second region. A manner in which the first region and the second region are set can be adjusted as appropriate. For example, a region in which a magnetic flux is relatively strong can be set as the first region, and a region in which a magnetic flux is relatively weak can be set as the second region. For example, it is assumed that a loop coil 111F, a loop coil 111G, and a loop coil 111J are arranged in the first region, and the other loop coils 111 are arranged in the second region. In such a case, the third number of times is used as the second number of times for the loop coil 111F, the loop coil 111G, and the loop coil 111J. In contrast, the fourth number of times is used as the second number of times for the other loop coils 111.

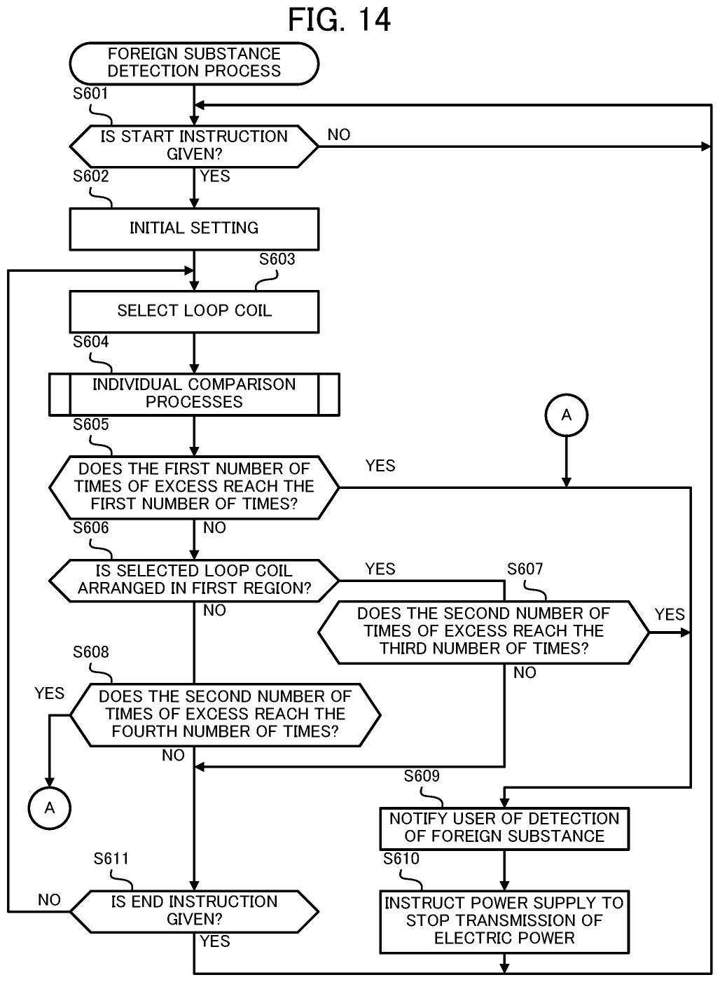

A foreign substance detection process executed by a foreign substance detection device 100 will now be described with reference to FIG. 14.

First, the detector 120 determines whether or not an instruction to start the foreign substance detection process is given (step S601). When determining that the instruction to start the foreign substance detection process is given (step S601: YES), the detector 120 executes an initial setting (step S602). When completing the process of step S602, the detector 120 selects a loop coil 111 (step S603). When completing the process of step S603, the detector 120 executes individual comparison processes (step S604).

When completing the individual comparison processes of step S604, the detector 120 determines whether or not the first number of times of excess reaches the first number of times (step S605). When determining that the first number of times of excess does not reach the first number of times (step S605: NO), the detector 120 determines whether or not the selected loop coil 111 is arranged in the first region (step S606). When determining that the selected loop coil 111 is arranged in the first region (step S606: YES), the detector 120 determines whether or not the second number of times of excess reaches the third number of times (step S607). When determining that the selected loop coil 111 is not arranged in the first region (step S606: NO), the detector 120 determines whether or not the second number of times of excess reaches the fourth number of times (step S608). The process of determining whether or not the selected loop coil 111 is arranged in the first region (process of step S606) may also be carried out before the process of determining whether or not the first number of times of excess reaches the first number of times (process of step S605). In such a case, when determining that the second number of times of excess does not reach the third number of times (step S607: NO), or determining that the second number of times of excess does not reach the fourth number of times (step S608: NO), the detector 120 carries out the process of determining whether or not the first number of times of excess reaches the first number of times (step S605).

When determining that the first number of times of excess reaches the first number of times (step S605: YES), determining that the second number of times of excess reaches the third number of times (step S607: YES), or determining that the second number of times of excess reaches the fourth number of times (step S608: YES), the detector 120 notifies a user of the detection of the foreign substance (step S609). When completing the process of step S609, the detector 120 instructs a power supply 220 to stop transmission of electric power (step S610). The process of instructing the power supply 220 to stop the transmission of the electric power (process of step S610) may also be carried out before the process of notifying the user of the detection of the foreign substance (process of step S609).

When determining that the second number of times of excess does not reach the third number of times (step S607: NO), or determining that the second number of times of excess does not reach the fourth number of times (step S608: NO), the detector 120 determines whether or not an instruction to end the foreign substance detection process is given (step S611). When determining that the instruction to start the foreign substance detection process is not given (step S601: NO), completing the process of step S610, or determining that the instruction to end the foreign substance detection process is given (step S611: YES), the detector 120 returns the process to step S601. When determining that the instruction to end the foreign substance detection process is not given (step S611: NO), the detector 120 returns the process to step S603.

In the present embodiment, the number of times varying depending on a position at which a loop coil 111 is arranged is used as the second number of times. Accordingly, the foreign substance 10 is detected at a speed depending on the importance, urgency, and/or the like of the detection of the foreign substance in a region in which a loop coil 111 is arranged in accordance with the present embodiment.

### Embodiment 5

Embodiments 1 to 4 describe the examples in which the foreign substance detection device 100 is disposed in the electric power transmission device 200. Embodiment 5 describes an example in which a foreign substance detection device 101 is disposed in an electric power reception device 300. Description of structures and processes similar to those in Embodiments 1 to 4 will be omitted or simplified.

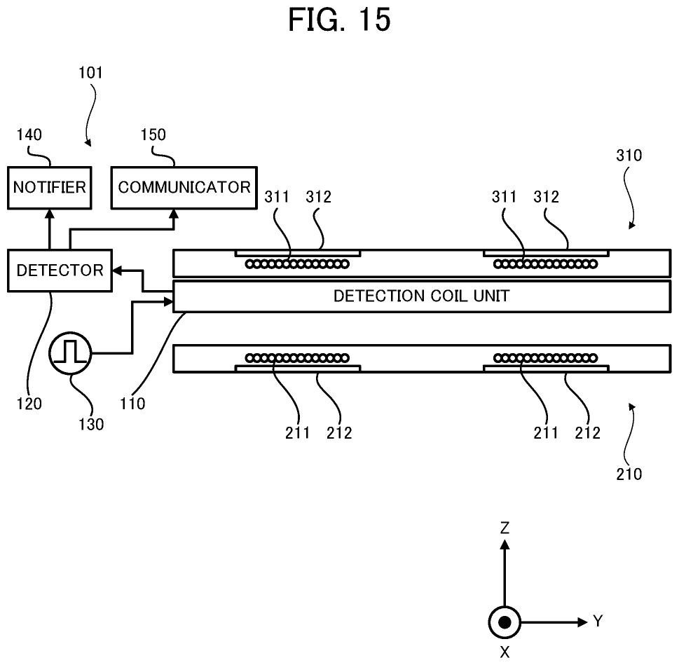

As illustrated in FIG. 15, the foreign substance detection device 101 includes a detection coil unit 110, a detector 120, a pulse generator 130, a notifier 140, and a communicator 150.

As illustrated in FIG. 15, the detection coil unit 110 is formed in a flat-plate shape, and is arranged on an electric power reception coil unit 310 so as to overlap an electric power reception coil 311 in planar view. The detector 120 determines whether or not a foreign substance is present in a region for detection on the basis of output values from loop coils 111 excited by applying pulsing voltage. The detector 120 controls the communicator 150 as well as the pulse generator 130 and the notifier 140,

The pulse generator 130 generates pulsing voltage for detecting a foreign substance, selects a loop coil 111, and applies the pulsing voltage to the loop coil 111. When the detector 120 detects a foreign substance, the notifier 140 notifies a user of the detection of the foreign substance. The communicator 150 transmits a signal for giving an instruction to stop transmission of electric power to an electric power transmission device 200 that transmits electric power to the electric power reception device 300 when the detector 120 determines that the foreign substance is present. In response to reception of the signal, a power supply 220 included in the electric power transmission device 200 stops supply of electric power to an electric power transmission coil unit 210 to stop the transmission of the electric power.

In the present embodiment, the foreign substance detection device 101 is disposed in the electric power reception device 300, and a signal for giving an instruction to stop transmission of electric power is transmitted to the electric power transmission device 200 when a foreign substance 10 is detected. Accordingly, the transmission of the electric power can be stopped for safety in the case of the detection of the foreign substance 10 even when the foreign substance detection device 101 is disposed in the electric power reception device 300 from various viewpoints, in accordance with the present embodiment.

### Alternative Example

The embodiments of the present disclosure have been described above. However, modifications and applications according to various forms can be made when the present disclosure is carried out. In the present disclosure, it is optional to adopt which ones of the structures, functions, and operations described in the embodiments described above. In addition to the structures, functions, and operations described above, further structures, functions, and operations may also be adopted in the present disclosure. The embodiments described above can be freely combined as appropriate. The numbers of the components described in the embodiments described above can be adjusted as appropriate. It will be appreciated that materials, sizes, electrical characteristics, and the like that can be adopted in the present disclosure are not limited to those described in the embodiments described above.

Embodiments 1 to 5 describe the examples in which the sensors used in the detection of the foreign substance are the loop coils 111. Various sensors other than the loop coils 111 can be adopted as sensors used in detection of a foreign substance. For example, temperature sensors, infrared sensors, and the like can be adopted as the sensors used in the detection of the foreign substance. Embodiments 1 to 5 describe the examples in which the plurality of sensors is used in the detection of the foreign substances. The number of sensors used in detection of a foreign substance may be one.

Embodiments 1 to 5 describe the examples in which a value for comparison, which is compared with threshold values, is a difference value between an output value from a sensor and a reference value. The value for comparison need not be the difference value itself as long as being a value based on the difference value. For example, the value for comparison may be a value calculated by subjecting the difference value to predetermined computation, or may be a value determined from the difference value with reference to a predetermined table.

Embodiment 1 describes the example in which the notifier 140 notifies the user of the terminal device 600 of the detection of the foreign substance 10 by transmitting information, representing the detection of the foreign substance 10, to the terminal device 600. A method in which the user is notified of the detection of the foreign substance 10 is not limited to the example. For example, the notifier 140 may directly notify the user of the detection of the foreign substance 10 through screen display, voice output, or the like. The notifier 140 may be formed to transmit information, representing the detection of the foreign substance 10, to equipment included in the electric vehicle 700.

Embodiments 2 and 3 describe the examples in which a higher priority is given to the individual comparison process for the first sensor when the difference value in the first sensor exceeds the second threshold value. When the difference value in the first sensor exceeds the first threshold value, the higher priority of individual comparison processes may be given to the first sensor. For example, individual comparison processes for the first sensor may be consecutively executed when the difference value in the first sensor exceeds the first threshold value. When the difference value in the first sensor exceeds the first threshold value, an individual comparison process for the first sensor may be executed in earlier order in a consecutive comparison process. When both a first sensor in which a difference value exceeds the second threshold value and a second sensor in which a difference value exceeds the first threshold value are present, it is desirable to give a higher priority to an individual comparison process for the first sensor than to an individual comparison process for the second sensor.

Embodiment 2 describes the example in which the individual comparison processes for the first sensor are ended to restart the consecutive comparison processes by consecutively executing the individual comparison processes for the first sensor at the predetermined number of times when the difference value in the first sensor exceeds the second threshold value in the execution of the consecutive comparison processes. The individual comparison processes for the first sensor may be maintained while the difference value in the first sensor exceeds the second threshold value. In other words, the detector 120 may end the individual comparison processes for the first sensor to restart the consecutive comparison processes in a case in which the difference value in the first sensor is less than the second threshold value, when consecutively executing the individual comparison processes for the first sensor.

In such a case, the detector 120 may restart in the middle of the consecutive comparison processes, or may restart the consecutive comparison processes from the beginning, when restarting the consecutive comparison processes. For example, the consecutive comparison processes are discontinued, and the individual comparison processes for the loop coil 111C are consecutively executed in a case in which the difference value in the loop coil 111C exceeds the second threshold value when the consecutive comparison processes are executed in the initial execution order. In such a case, the individual comparison processes for the loop coil 111C are ended when the difference value in the loop coil 111C is less than the second threshold value. In this case, the detector 120 may restart the consecutive comparison processes from the individual comparison processes for the loop coil 111D, or may restart the consecutive comparison processes from the individual comparison processes for the loop coil 111A.

Embodiment 4 describes the example in which the second number of times is set to two stages of the third number of times and the fourth number of times depending on the positions at which the sensors are arranged. The second number of times may be set to three or more stages depending on the positions at the sensors are arranged.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. A foreign substance detection device comprising:
a sensor; and
a detector that determines presence or absence of a foreign substance based on results of comparison between a value for comparison, based on an output value from the sensor, and threshold values, wherein
the threshold values comprise a first threshold value and a second threshold value that is greater than the first threshold value, and
the detector determines that the foreign substance is present when a number of times at which the value for comparison exceeds the first threshold value reaches a first number of times, and determines that the foreign substance is present when a number of times at which the value for comparison exceeds the second threshold value reaches a second number of times smaller than the first number of times.

2. The foreign substance detection device according to claim 1, comprising a plurality of the sensors, wherein
the detector executes consecutive comparison processes in which individual comparison processes of comparing the value for comparison and the threshold values for one of the sensors are executed in predetermined order for the plurality of sensors, and
when the value for comparison in a first sensor among the plurality of sensors exceeds the second threshold value in the execution of the consecutive comparison processes, the detector consecutively executes the individual comparison processes for the first sensor.

3. The foreign substance detection device according to claim 2, wherein the detector restarts the consecutive comparison processes in a case in which the value for comparison in the first sensor is less than the second threshold value when consecutively executing the individual comparison processes for the first sensor.

4. The foreign substance detection device according to claim 1, comprising a plurality of the sensors, wherein
the detector repeatedly executes consecutive comparison processes in which individual comparison processes of comparing the value for comparison and the threshold values for one of the sensors are executed for the plurality of sensors in predetermined order, and
when the value for comparison in a first sensor among the plurality of sensors exceeds the second threshold value in the execution of one of the consecutive comparison processes, the detector executes the individual comparison process for the first sensor in earlier order in the consecutive comparison process, and then executes the subsequent consecutive comparison processes.

5. The foreign substance detection device according to claim 1, further comprising a notifier that notifies at least one of a user and predetermined equipment of presence of the foreign substance when the detector determines that the foreign substance is present.

6. An electric power transmission device comprising:
an electric power transmission coil formed by winding a conductive wire; and
the foreign substance detection device according to claim 1.

7. The electric power transmission device according to claim 6, further comprising a power supply that supplies alternating-current power to the electric power transmission coil,
wherein the power supply stops supply of the alternating-current power to the electric power transmission coil when the detector determines that the foreign substance is present.

8. The electric power transmission device according to claim 6, wherein
the foreign substance detection device comprises a plurality of the sensors,
the plurality of sensors is arranged to cover the electric power transmission coil, and
the detector uses a number of times, varying depending on positions at which the plurality of sensors is arranged, as the second number of times.

9. An electric power reception device comprising:
an electric power reception coil formed by winding a conductive wire; and
the foreign substance detection device according to claim 1.

10. The electric power reception device according to claim 9, further comprising a communicator that transmits a signal for giving an instruction to stop transmission of electric power to an electric power transmission device that transmits electric power to the electric power reception device when the detector determines that the foreign substance is present

11. The electric power reception device according to claim 9, wherein
the foreign substance detection device comprises a plurality of the sensors,
the plurality of sensors is arranged to cover the electric power reception coil, and
the detector uses a number of times, varying depending on positions at which the plurality of sensors is arranged, as the second number of times.

12. An electric power transmission system comprising:
the electric power transmission device according to claim 6; and
an electric power reception device that receives electric power from the electric power transmission device.

13. An electric power transmission system comprising:
the electric power reception device according to claim 9; and
an electric power transmission device that transmits electric power to the electric power reception device.
